(19) United States
(12) Patent Application Publication
(10) Pub. No.: US 2016/0002108 A1
(43) Pub. Date: Jan. 7, 2016

(54) Targeted Air Control for Carbon Containing Fly Ash

(71) Applicant: W.R. Grace & Co.-Conn., Columbia, MD (US)

(72) Inventors: Ying CHEN, Arlington, MA (US); Josephine CHEUNG, Lexington, MA (US); Leslie A. JARDINE, Burlington, MA (US); Joshua DETELLIS, Woburn, MA (US); Xiaohong WANG, Arlington, MA (US)

(21) Appl. No.: 14/441,678

(22) PCT Filed: Dec. 18, 2014
(86) PCT No.: PCT/US2014/071180

§ 371 Date: May 8, 2015

Related U.S. Application Data
(60) Provisional application No. 61/919,916, filed on Dec. 23, 2013.

(51) Int. Cl. C04B 24/02; C04B 24/12; C04B 24/08; C04B 28/04; C04B 18/08

(52) U.S. Cl. CPC C04B 24/026; C04B 28/04; C04B 18/08; C04B 24/085; C04B 24/124

(57) ABSTRACT

Compositions and methods of the present invention comprise the use of at least one alkoxylated fatty compound comprising at least one propylene oxide group, the alkoxylated fatty compound having a turbidity most preferably greater than 1000 NTU (as measured in a 0.2 weight percent aqueous solution) and carbon dispersing compound (e.g., lignosulfonate) to reduce carbon spotting in mortars and concretes containing a carbon-bearing fly ash having a methylene blue (MB) value of at least 1 mg/g or greater (as 10 determined according to ASTM C1777-13). The compositions may, for example, be combined as dry powder with the carbon-bearing fly ash where the fly ash is produced, or in aqueous liquid composition form, such as would be suitable for dispensing at a concrete ready-mix plant. Exemplary additive or admixture compositions may further comprise air entraining agents, alkanolamines, or both.

### FIELD OF THE INVENTION

The invention relates generally to additives for use in cement or concrete manufacture and fly ash treatment, and more particularly to compositions and methods for controlling air and eliminating spotting in cementitious materials containing carbon-bearing fly ash, especially fly ash which contains activated carbon.

### BACKGROUND OF THE INVENTION

In U.S. Pat. No. 7,976,625 B2 (Cognis IP Management GmbH), the inventors Mao et al. described numerous advantages in using fly ash to replace a portion of cement that was used in making concrete and other cementitious materials. Among the most significant advantages were reduced permeability and improved workability. However, one major problem was that the carbon present in fly ash (and the high carbon content in off-grade fly ash) could adsorb surfactants or Air-Entraining Admixtures (“AEAs”) and thus interfere with generation of the fine micro-bubble structure needed for imparting freeze/thaw durability to mortars and concretes. Mao '615 taught that the fly ash could be treated with a compound selected from an amphoteric, alkyl polyglycoside, ester, a derivative of triglyceride, fatty alcohol, alkoxylated fatty alcohol, alkoxylated polyhydric alcohol, and mixtures thereof.

Activated carbon in fly ash especially poses a challenge for AEA usage in concrete. To reduce mercury emissions, manufacturers inject activated carbon into the flue gas produced by coal-fired power plants, so as to adsorb vaporized mercury. The activated carbon in the collected fly ash possesses an enormous surface area, in excess of 500 meter²/gram, resulting in nearly complete adsorption of the AEA. As resulting levels of the air entrainment are decreased, the desired entrained air structure cannot be satisfactorily achieved in the concrete matrix, such that manufacturers will avoid using carbon-bearing fly ashes.

Due to the negative impact of carbon on air entrainment, the American Society for Testing and Materials (ASTM) has set a limit on the loss on ignition (LOI) at 6%. LOI is a measure of total unburned carbon contained in the fly ash (regardless of carbon surface area). LOI value alone does not provide good indication of concrete air entrainment performance, because, with activated carbon, even a low LOI fly ash can pose a problem for air entrainment.

The present inventors believe that improved carbon fly ash treatments are still necessary, because not all air entrainment issues are resolved by the prior art approaches. For example, the presence of carbon tends to cause abnormally high AEA doses to be used, particularly when the user is targeting normal levels of entrained air in plastic concretes (e.g., 5%-8% by volume). Depending on the amount of surface area and nature of its surface modification, the carbon in the fly ash can adsorb different molecules at different rates, such that the performance of admixtures which employ various entrainer and detrainer components can become unbalanced.

In addition, continued adsorption of AEAs by the carbon can result in overall air loss when the concrete is transported from batch plant to job site, as the air content is tested usually at the batch plant only. While small and predictable changes of about +/−2% in the entrained air levels are acceptable, larger losses of air during transport could go unnoticed until after the concrete is poured and hardened in place. The result might be that the volume of the hardened concrete air void structure is much less than expected.

In view of the adverse effects caused by the presence of carbon in fly ash, the present inventors believe there is a need for novel and inventive improvements whereby robust air entrainment can be achieved in fly ash-containing cementitious materials.

Moreover, the present inventors believe there is an urgent need to treat fly ash that contains activated carbon.

### SUMMARY OF THE INVENTION

In surmounting the disadvantages of the prior art, the present invention provides additive compositions and methods for achieving targeted air control in carbon-bearing fly ash-containing cementitious compositions such as mortars, masonry, and concrete, and also for eliminating spotting due to the presence of activated carbon. The term “concrete” will be used as an example of cementitious compositions treated by the present invention.

Exemplary compositions and methods of the present invention help to control air in hydratable cementitious compositions which contain a carbon-bearing fly ash having a methylene blue (MB) value of at least 1 milligram/gram (mg/g) or greater. The MB value reflects the amount of methylene blue dye absorbed per gram of material being tested, and is done in accordance with ASTM C1777-13 (“Standard Test Method for Rapid Determination of the Methylene Blue Value for Fine Aggregate or Mineral Filler Using a Colorimeter”). The present invention involves the use of an alkoxylated fatty compound comprising at least one propylene oxide group and at least one saturated or unsaturated alkyl chain of 8 to 22 carbons, the alkxoylated fatty compound having a turbidity value which exceeds 50 Nephelometric Turbidity Units or “NTU” (as measured in a 0.2 weight percent aqueous solution), and at least one agent for dispersing carbon within an aqueous environment (e.g., a concrete slurry or mix). An exemplary carbon-dispersing agent is selected from the group of lignosulfonate, melamine sulfonate compound, naphthalene sulfonate compound, polyvinyl alcohol, polyvinylpyrrolidone, urea formaldehyde compound, and polysaccharide.

The present inventors believe that treatment of carbon-bearing fly ash should be done when the methylene blue (MB) value of the carbon-bearing fly ash is at least 1 mg/g or greater (as determined in accordance with ASTM C1777-13).

The phrase “carbon-bearing fly ash-containing” is intended to refer to cementitious compositions such as mortar and concrete made using fly ash that carries or contains carbon which operates to detrain air or otherwise to diminish the effect of air entraining agents (AEAs) within mortar and concrete.

Exemplary embodiments include an additive or admixture composition which can be combined, in dry powder form or aqueous liquid composition form, with carbon (such as activated carbon which is used for treating mercury emissions in a furnace), carbon-bearing fly ash, or carbon-bearing fly ash-containing cementitious compositions. For example, a dry powder comprising the alkoxylated fatty compound and carbon-dispersing agent can be mixed with carbon-bearing fly ash with an MB value of at least 1 (mg/g) or greater. As another example, a powder or liquid composition containing the components can be dispensed into a concrete ready-mix or precast concrete plant.

Further exemplary compositions and methods of the invention comprise the use of (i) at least one air entraining agent; (ii) at least one alkanolamine selected from the group consisting of methyldiethanolamine (MDEA), diethanolamine (DEA), triethanolamine (TEA), triisopropanolamine (TIPA), diethanolisopropanolamine (DEIPA), diisopropanolethanolamine, tetrahydroxy-ethylethylenediamine, tetra-hydroxyisopropyl-ethylenediamine, or mixtures thereof; or (iii) a mixture of component (i) and component (ii). Thus, where the alkoxylated fatty compound and carbon-dispersing agent are mixed with carbon-bearing fly ash, an alkanolamine and/or air entraining agent (or both) may be introduced at the same time or later introduced at a concrete plant.

The present inventors envisage that the most significant embodiments of the invention would involve (a) addition of the above-described alkoxylated fatty compound and carbon-dispersing agent to carbon-bearing fly ash, wherein the methylene blue (MB) value of the carbon-bearing fly ash is determined to be at least 1 (mg/g) or greater (the MB value being determined in accordance with ASTM C1777-13), before this fly ash is used at a cement or concrete manufacturing plant; or (b) addition of the above-described alkoxylated fatty compound and carbon-dispersing agent, in further combination with at least one air entraining agent, at the concrete mix (e.g., ready-mix) or precast concrete manufacturing plant.

Consequently, a further exemplary composition and method, particularly suited for use in modifying mortar or concrete mixes and dispensable in either a dry powder or liquid pumpable form, comprises: (A) an air entraining agent (“AEA”) which, for example, may be selected from preferred wood resin (vinsol resin, rosin), sulfonated hydrocarbon, fatty acids, and synthetic surfactants) in the amount of 0.1% to 60% based on total dry weight of the additive composition; (B) at least one alkoxylated fatty compound comprising at least one propylene oxide group, the alkoxylated fatty compound having a turbidity larger than 50 NTU, and more preferably larger than 500 NTU (as measured in a 0.2 weight percent solution), the alkoxylated fatty compound being present in the amount of 0.1% to 75% based on total dry weight of the additive composition; (C) at least one agent for dispersing carbon within an aqueous environment (for example, the carbon-dispersing agent may comprise lignosulfonate, melamine sulfonate compound, naphthalene sulfonate compound, polyvinyl alcohol, polyvinylpyrrolidone, urea formaldehyde compound, a polysaccharide, or mixture thereof), the carbon dispersing agent being present in the amount of 25% to 99.8% based on total dry solids in the additive composition; (D) optionally at least one alkanolamine present in the amount of 0% to 50% based on total dry weight of the additive composition; and (E) optionally water in the amount of 0% to 99.8% based on total weight of the additive composition.

As previously mentioned, the composition may be introduced to carbon-bearing fly ash earlier or later in the cementitious construction material supply chain. For example, exemplary methods for treating carbon-bearing fly ash compositions comprise introducing the above-described additive components into carbon-bearing fly ash (wherein the MB value is 1-7 (mg/g) as determined in accordance with ASTM C1777-13), or carbon-bearing fly ash-containing cement or concrete, or, alternatively, combining the additive components with a carbon-bearing fly ash before it is combined with a cement binder and/or aggregates used for making cement mortar or concrete.

In an exemplary embodiment of the invention, carbon-bearing fly ash can be treated by adding the above-described additive composition into a cementitious system which contains the fly ash. In other embodiments, the additive composition or components thereof, may be applied onto the carbon-bearing fly ash to form a pre-treated fly ash, which is then mixed with cement, water, air entraining agents, aggregate, and optionally other conventional admixtures used for making mortars and concretes.

In still further embodiments of the invention, the additive formulation or components thereof is/are applied onto activated carbon to provide a pre-treated carbon, which is then collected with fly ash that has been precipitated from flue gas in the coal burning plant. In other embodiments, the additive is combined with cement before, during, or after fly ash addition.

The formulation and method disclosed achieve targeted air control in cementitious systems wherein a carbon-bearing fly ash having an MB value of 1 (mg/g) or greater (ASTM C1777-13) is used as supplementary cementing material (SCM). One exemplary aspect of this invention is to provide a formulation product which comprises an alkoxylated fatty compound and preferably at least one air entraining additive in combination with a carbon-dispersing agent selected from lignosulfonate, naphthalene sulfonate formaldehyde condensates (NSFC), melamine sulfonate formaldehyde condensate (MSFC), polyvinyl alcohol, polyvinylpyrrolidone (PVP), and mixtures thereof.

Preferred embodiments comprise the use of at least one amine, such as triisopropanolamine, methyldiethanolamine, diethanolamine, triethanolamine, diethanolisopropanolamine, diisopropanolethanolamine, tetra hydroxy-ethylethylenediamine, tetra-hydroxyisopropyl-ethylenediamine, or mixtures thereof. Triethanolamine, triisopropanolamine, and diethanolisopropanolamine, and combinations thereof are most preferred.

Other advantages and features of the invention may be discussed in further detail hereinafter.

### DETAILED DESCRIPTION OF EXEMPLARY EMBODIMENTS

The term “cement” as used herein includes hydratable Portland cement which is produced by pulverizing clinker consisting of hydraulic calcium silicates and one or more forms of calcium sulfate (e.g., gypsum) as an interground additive. The term “cementitious” as used herein refers to materials that comprise Portland cement or which otherwise function as a binder to hold together fine aggregates (e.g., sand), coarse aggregates (e.g., crushed gravel), or mixtures thereof. Included in the definition of cement and cementitious materials, and often referred to as supplemental cementitious materials, such as include fly ash, granulated blast furnace slag, limestone, natural pozzolans, or mixtures of these materials.

The term “hydratable” refers to cement and/or cementitious materials that are hardened by chemical interaction with water. Portland cement clinker is a partially fused mass primarily composed of hydratable calcium silicates. The calcium silicates are essentially a mixture of tricalcium silicate (3CaO.SiO₂ “C₃S” in cement chemists notation) and dicalcium silicate (2CaO.SiO₂, “C₂S”) in which the former is the dominant form, with lesser amounts of tricalcium aluminate (3CaO.Al₂O₃, “C₃A”) and tetracalcium aluminoferrite (4CaO.Al₂O₃.Fe₂O₃, “C₄AF”). See e.g., Dodson, Vance H., Concrete Admixtures (Van Nostrand Reinhold, New York N.Y. 1990), page 1.

Typically, Portland cement is combined with one or more other cementitious materials, such as the foregoing supplemental cementitious materials, and provided as a blend. Cement and cementitious materials are typically combined with fine aggregates to provide “mortars”; and cement may be combined with both fine and coarse aggregates to provide “concrete.” Hence, the term “concrete” may be used herein to refer to all cementitious materials which include aggregates.

The term “fly ash” as used herein shall mean “finely divided residue that results from the combustion of ground or powdered coal and that is transported by flue gasses.” This definition is consistent with that set forth in ASTM C618-05 (paragraph 3.1.2). The ASTM specification describes two Classes of fly ash for use as a mineral admixture in Portland cement concrete. Class F fly ash is normally produced by burning anthracite or bituminous coal. It is described as having pozzolanic properties. Class C fly ash is normally produced by burning lignite or sub-bituminous coal. It has more cementitious properties than Class F fly ash, primarily due to its higher calcium content. Because of the more cementitious properties of Class C fly ash, it bonds more strongly than Class F fly ash when combined with water and allowed to harden. Some amounts of carbon is typically seen in fly ash as it is a residue from burning of coal.

The present invention is intended to treat fly ash and fly ash-containing cementitious materials having activated carbon which is added into the fly ash (such as for adsorbing mercury) and/or residual carbon from unburned coal. Thus, the carbon may result from these or other sources, and the amount of additive or admixture treatment compound to be used may be determined using known tests (e.g., MB test as described herein) regardless of the source of carbon.

The terms “additive” and “admixture” are used herein interchangeably to refer to compositions that are added to fly ashes or added to or combined with cement to form mortars, masonry, and/or concrete; although, in a more classic sense, the term “additive” is used to refer to a composition used in grinding manufacture of Portland cement or any of the other cementitious materials, independently or in any combination; while the term “admixtures” is used to refer to a composition added into a mortar and concrete to modify one or more properties therein.

Percentages and amounts of components described herein are intended to be described in terms of total dry weight of total solids (not including carrier materials such as limestone, silica, calcined fly ash, or other materials used for conveying the alkoxylated fatty compound and optionally other active components of the present invention) in the additive composition, unless otherwise indicated. Any water component amount is intended to be expressed as a percentage of the total weight of the aqueous liquid (additive) composition.

Exemplary additives and admixture compositions of the present invention may be combined with carbon-bearing fly ash having an MB value of 1 mg/g or greater (as measured in accordance with ASTM C1777-13), cement, mortar, or concrete, as an aqueous liquid composition or in dry powder form. For example, exemplary compositions of the present invention comprise: the aforementioned alkoxylated fatty compound having at least one propylene oxide group and at least one saturated or unsaturated alkyl chain of 8-22 carbons; and at least one agent for dispersing carbon (when in an aqueous environment such as wet mortar or concrete); and can be provided in dry powder form (such as on a carrier such as silica, fly ash (e.g., calcined fly ash), limestone, or other non-absorbing material), and thus can be mixed with carbon-bearing fly ash, such as at coal burning power plants where the fly ash is generated, or at a cement manufacturing plant where fly ash is interground with cement clinker. As another example, pre-treated carbon-bearing fly ash (treated in accordance with the present invention) can be added into masonry, mortar, or concrete mixes; or can be interground with cement clinker.

Thus, in further exemplary compositions and methods of the invention, the additive comprising at least the alkoxylated fatty compound, and optionally the carbon-dispersing compound, alkanolamine, and AEA, are loaded onto a carrier selected from silica, calcined fly ash, limestone, or mixture thereof, and combined with carbon-bearing fly ash.

If used in the manufacture of cement or other cementitious materials, additive compositions and methods of the present invention may be used with or in conventional grinding mills, such as ball mills (or tube mills), as well as other mill designs, such as in mills using rollers (e.g., vertical rollers, rollers on tables, etc.). See e.g., U.S. Pat. No. 6,213,415 of Cheung. The additives may be combined with fly ash, or combined with cement and fly ash, including manufacturing operations wherein cement clinker is interground with fly ash (and optional additional pozzolanic materials) to produce finished cement.

As mentioned in the summary section above, an exemplary compositions and methods comprising the use of an alkoxylated fatty compound and carbon-dispersing agent, may further comprise the use of (i) at least one air entraining agent; (ii) at least one alkanolamine selected from the group consisting of methyldiethanolamine (MDEA), diethanolamine (DEA), triethanolamine (TEA), triisopropanolamine (TIPA), diethanolisopropanolamine (DEIPA), diisopropanolethanolamine, tetrahydroxy-ethylethylenediamine, tetra-hydroxyisopropyl-ethylenediamine, or mixtures thereof; or (iii) a mixture of component (i) and component (ii).

As further mentioned in the summary section above, exemplary additive composition and methods useful for achieving targeted air control in carbon-bearing fly ash-containing cementitious compositions such as mortar mixes and concrete mixes, comprise: (A) an air entraining agent (which by way of example may be preferably selected from the group consisting of wood resin (vinsol resin, rosin), sulfonated hydrocarbon, fatty acids, and synthetic surfactants) in the amount of 0.1% to 60% based on total dry weight of the additive composition; (B) at least one alkoxylated fatty compound comprising at least one propylene oxide group, the alkoxylated fatty compound having a turbidity larger than 50 NTU, more preferably larger than 500 NTU, and most preferably having an NTU value larger than 1000 NTU (as measured within a 0.2 weight percent aqueous solution), the alkoxylated fatty compound being present in the amount of 0.1% to 75% based on total dry total weight solids in the additive composition; (C) at least one agent for dispersing carbon within an aqueous environment (the carbon-dispersing agent being selected from the group of lignosulfonate, melamine sulfonate compound, naphthalene sulfonate compound, polyvinyl alcohol, polyvinylpyrrolidone, urea formaldehyde compound, a polysaccharide, or mixtures thereof), the carbon dispersing agent being present in the amount of 25% to 99.8% based on total dry weight solids in the additive composition; (D) at least one alkanolamine present in the amount of 0% to 50% based on total dry weight solids in the additive composition; and (E) water in the amount of 0% to 99.8% based on total weight (solids and liquid) of the additive composition.

Again, all components of additive compositions and cementitious compositions are defined in terms of percentage based on total dry weight of additive components (not including carrier materials such as limestone, silica, calcined fly ash, or other materials used for conveying the alkoxylated fatty compound and other active components); and any ratios of components described herein are described in terms of respective solids weight, unless otherwise indicated.

Component A.

The term “air-entraining agent” (AEA) refers to a surface active agent that generates air bubbles when added into cementitious compositions. Exemplary AEAs may be selected from traditional anionic, cationic, zwiterionic, and nonionic surfactants. Preferred AEAs for purposes of the present invention include wood resin (vinsol resin, rosin resin), sulfonated hydrocarbon, fatty acids, synthesis surfactants, and mixtures thereof. Further examples of AEA include rosin acid and its derivative, sodium dodecyl sulfate, sodium dodecylbenzene sulfonate, ammonium lauryl sulfate, potassium lauryl sulfate, sodium lauryl ether sulfate, sodium lauroyl sarcosinate, sodium myreth sulfate, sodium pareth sulfate, cetrimonium chloride, dimethyldioctadecylammonium chloride, tetramethylammonium hydroxide, tetradecyldimethylamine oxide, dimethyl tallowalkylamine oxide, nonyl phenol, nonyl phenol ethoxylates, alkyl polyglycosides, octyl phenol ethoxylates, and tall oil fatty acid.

It is contemplated that a number of air entraining agents (AEAs) can be used for component “A” in the additives and methods of the present invention. Of the preferred wood resin (vinsol resin, rosin), sulfonated hydrocarbon, fatty acids, and synthetic surfactants, which are used in the amount of 0.0% to 60% based on total dry weight solids in the additive composition, the most preferred are wood resin and derivatives thereof. Other preferred AEAs include sulfonated hydrocarbon and tall oil fatty acid.

Component B.

The term “alkoxylated” as used herein means and refers to a compound having at least one propylene oxide (PO) unit; and optionally it may or may not contain ethylene oxide (EO) units and/or butylenes oxide units. If both PO and EO units are employed, the distribution of PO and EO units may be random or in block form, or could also be linear or branched form. Preferably, alkoxylated compounds of the invention comprise 5 to 200 PO groups occur within each molecule; and, more preferably, between 16 to 50 PO groups per molecule. Similarly, preferably 0 to 100 EO or butylenes oxide groups are used within each molecule, and, if EO groups are present, they constitute no more than 50% by mole of the alkoxylated groups within each molecule. In further exemplary embodiments, the molar ratio of EO/PO groups is 0 to 1. The present inventors believe that the presence of PO groups facilitates the formation of micelles and results in the stabilizing of air void structure in concrete, and, as a result, the PO unit is essential for air entrainment control. Alkoxylated fatty compounds having no PO units are less desirable and excluded from the present invention, and these non-PO-containing alkoxylated fatty compounds include POE(5) C6-C12 alcohol, POE(23) C6-C12 alcohol, POE(10) soybean oil, POE(42) soybean oil and POE(9) nonyl-phenol.

Exemplary alkoxylated “fatty compounds” contemplated for use in the present invention contain saturated or unsaturated alkyl chain of 8 to 22 carbons, and, more preferably, 12 to 20 carbons, and, most preferably, 14 to 18 carbons. Preferably, the alkoxylated fatty compound is a fatty alcohol, fatty acid, fatty amide, fatty ester, fatty amine. Another preferred alkoxylated fatty compound is propoxylated tallow amine. In still further exemplary embodiments, the alkoxylated fatty compound contains 0-100 moles of ethylene oxide group and 0-100 moles of butylene oxide group. Examples of fatty compounds are oleyl alcohol, cetyl alcohol, palmitoleyl alcohol, stearyl alchohol, palmitoleic acid, sapienic acid, oleic acid, vaccenic acid, linoleic acid, stearic acid and cocamide.

As summarized above, alkoxylated fatty compounds used in the compositions and methods of the present invention should have a turbidity larger than 50 NTU and more preferably larger than 500 NTU (as measured in a 0.2 weight percent aqueous solution). The alkoxylated fatty compound is preferably present in the amount of 0.1% to 75% based on total dry weight solids of active components in the additive composition.

Turbidity represents the cloudiness or haziness of a fluid caused by individual liquid or solid particles. Turbidity in water can be measured by a nephelometer, a device that collects a scattered light beam signal caused by small particles in water. Units of turbidity as determined using a calibrated nephelometer are called Nephelometric Turbidity Units (designated as “NTU”). A higher NTU number indicates increased cloudiness in the solution. Turbidity measurements are affected by particles within an aqueous solution, and accordingly the turbidity reading of an unstable aqueous solution will change over time due to particle settlement or separation. The turbidity value for a given amount of particles will also depend on particle size and concentration, such that a water soluble compound or very hydrophobic compound are likely to have little impact on solution turbidity due to lack of emulsion or suspension particle formation. The tendency of a compound to form emulsion or suspension can be associated with its aqueous solution turbidity. The present inventors believe that this tendency to form emulsion or suspension in solution is important to stabilizing air content in cementitious compositions.

The turbidity of an aqueous solution may be measured, for purposes of the present invention, with a HACH™ 2100N turbidimeter at 20 degrees Celcius under the NTU unit mode with “Ratio” on, “Signal avg” off, and “Auto range” option. The turbidimeter was calibrated using a stabilized formazin turbidity standard supplied by the HACH Company, and this included a set of five sealed vials of <0.1, 20, 200, 1000, and 4000 NTU standards. Water (99.8 g) and alkoxylated fatty compound (0.2 g) were mixed for 15 minutes using mechanical stirrer at 600 rpm, and the turbidity of the resulting mixture was measured within 1 minute after mixing. A desired alkoxylated fatty compound forms a milky white solution at 0.2 wt % in water, and has a turbidity value larger than 50 NTU and more preferably larger than 500 NTU under the above testing condition. Distilled water can be used for measuring turbidity, but it is not required.

In still further exemplary compositions and methods of the invention, an exemplary alkoxylated fatty compound is employed which has an ethylene oxide (EO) to alkylene oxide molar ratio of less than 50%, and, more preferably, the EO to alkylene oxide molar ratio is less than 35%. In other words, an exemplary alkoxylated fatty compound as contemplated for use in the present invention comprises (i) ethylene oxide (EO); (ii) propylene oxide (PO), and (iii) optionally butylene oxide (BO), wherein the molar ratio of ethylene oxide to total alkylene oxide (EO/EO+PO+BO) is equal to or less than fifty percent (≦50%).

In still further exemplary embodiments of the invention, the alkoxylated fatty compound comprises ethylene oxide (EO) groups and propylene oxide (PO) groups wherein EO to PO molar ratio is 0:100 to 50:50, and, more preferably, the EO:PO ratio is 0:100 to 35:65.

In still further exemplary compositions of the invention comprise the component (A) air entraining agent and the component (B) at least one alkoxylated fatty compound in a weight ratio (A):(B) of 10:1 to 1:10, and, more preferably, the ratio is 3:1 to 1:6.

Component C.

As summarized above, exemplary compositions and methods of the invention involve the use of one or more agent(s) for dispersing carbon within an aqueous environment (as presented by mortar or concrete containing hydration water), the carbon-dispersing agent being selected from the group of lignosulfonate, melamine sulfonate compound, naphthalene sulfonate compound, polyvinyl alcohol, polyvinylpyrrolidone, urea formaldehyde compound, a polysaccharide, the carbon dispersing agent being present in the amount of 25% to 99.8% based on total dry weight solids in additive composition. Preferred carbon-dispersing agents are lignosulfonates, such as calcium lignosulfonate, sodium lignosulfonate, lignosulfonate obtained as a byproduct from a Kraft process, and mixtures thereof. The term “dispersing” as used herein refers to the ability to attach to particle surfaces to prevent agglomeration of particles or to alter surface properties of the particles within an aqueous suspension; and, without intending to be limited by theory, the present inventors suspect that these dispersing agents may also block adsorption of air entraining agents by carbon.

Component D.

As summarized above, exemplary additive compositions of the invention may contain one or more alkanolamines. The alkanolamine component may comprise methyldiethanolamine, diethanolamine, triethanolamine, triisopropanolamine, diethanolisopropanolamine, diisopropanolethanolamine, tetrahydroxy-ethylethylenediamine, tetra-hydroxyisopropyl-ethylenediamine, or mixtures thereof. Triethanolamine, triisopropanolamine, and diethanolisopropanolamine, and combinations thereof, are among the most preferred. In exemplary embodiments, the relative amount of particular amine or amines used can be dictated in accordance with the preferences of the user.

Component E.

Water may be added to provide a liquid aqueous additive composition which may be dispensed or metered conveniently into cement or into the manufacturing process used to make cement, or as a liquid admixture during the manufacture of mortar or concrete.

Examples of formulated additive compositions can comprise various component combinations. For example, an exemplary formulated composition for achieving targeted air control and prevention of carbon spotting can comprise an AEA pre-mixed with an alkoxylated fatty compound and a lignosulfonate, naphthalene sulfonate formaldehyde condensates (NSFC), melamine sulfonate formaldehyde condensate (MSFC), polyvinyl alcohol, polyvinylpyrrolidone (PVP), or mixtures thereof. Further exemplary additive formulations also include alkanolamines as described in component D.

Exemplary methods of the present invention, as summarized above, comprise combining the above-described additives into a carbon-bearing fly ash-containing cementitious composition, such as into a mortar or concrete, or into a fly ash as a pre-treatment before the fly ash is combined with the cementitious compositions.

Accordingly, an exemplary method comprises combining with a carbon-bearing fly ash having an MB value of 1 mg/g or greater (ASTM C1777-13), the following components: air entraining agent, at least one alkoxylated fatty compound having at least one propylene oxide group and a turbidity higher than 50 NTU, and more preferably higher than 500 NTU (as measured in a 0.2 weight percent aqueous solution), at least one agent for dispersing carbon within an aqueous environment, optionally an alkanolamine, and water. Preferably, the components are mixed together to provide a unified liquid aqueous composition before addition to fly ash or to a fly-ash containing cementitious composition.

The present inventors discovered that lignosulfonates are preferred in the present invention because they can improve dosage efficiency. Component C may also be selected from naphthalene sulfonate formaldehyde condensates (NSFC) and melamine sulfonate formaldehyde condensates (MSFC), and may be formulated into the composition with or without lignosulfonate. It is contemplated that NSFC and MSFC will have similar effect as the lignosulfonate as described above.

Lignosulfonate, polyvinyl alcohol, and polyvinylpyrrolidone will also each allow a reduction in carbon spotting, and this was discovered by the present inventors before screeding and after vibration of mortar prism samples made under EN196. Without being bound by theory, the inventors believe that these agents make the activated carbon more hydrophilic, maintaining the presence of activated carbon in the bulk aqueous matrix of a cementitious system, thereby preventing the rise of activated carbon to the surface of a vibrated cementitious system whereby the activated carbon would otherwise give rise to discoloration and spotting. Such compounds, along with NSFC, MSFC, urea-formaldehyde polymer, and polysaccharides, may be used alternatively to minimize spotting due to the use of activated carbon particles.

In further exemplary embodiments, one or more viscosity modifying agents can be used for prolonging shelf life of the formulated additive (or admixture) composition. The term viscosity modifying agent refers to a substance that controls the viscosity, stability, and/or thickness of a liquid composition. Examples of conventional viscosity modifying agents include xanthan gum, cera alba, guar gum, welan gum, diutan gum, and high molecular weight polyethylene oxide. It is possible that organic polymer thickeners or stabilizers (such as certain acrylic polymers thickeners) and polyvinyl alcohol may also be used to modify the viscosity of the composition. An exemplary composition and method of the invention thus further comprises the use of one or more of the above-mentioned thickening agents; such as diutan gum, welan gum, xanthan gum, or mixture thereof.

The invention provides targeted air control in cementitious systems that contain carbon-bearing fly ash, and, hence, compositions and methods of the invention contain one or more of the following constituents: cement, aggregate, water, an air entraining agent (AEA), and alkoxylated fatty compound, carbon-dispersing agent and one or more alkanolamines or other agents. Depending on the carbon and fly ash content, each of the AEA, alkoxylated fatty compound, and additional carbon-dispersing agents may each be added in an amount of 2 to 1000 parts per million (ppm) based on total cementitious material by solid weight. The methylene blue (MB) test as described by ASTM C1777-13 can be used for estimating the adsorption capacity of the carbon-bearing fly ash, and an empirical correlation can be established between MB value and treatment levels. Higher MB value requires higher treatment levels.

In other exemplary embodiments, Components A and B may each be added in the amount of 2 to 200 ppm (and more preferably 4-40 ppm), Component C may be added in the amount of 50 to 1000 ppm, and Component D may be added in the amount of 25-800 ppm, based on total cementitious material by solid weight.

The relative amounts and ratios of the various components may well depend on the method of addition and mixing.

In another exemplary embodiment of the invention, a method to achieve targeted air control comprises applying the additive containing AEA, alkoxylated fatty compound, and carbon-dispersing agent, to carbon-bearing fly ash having an MB value of 1 (mg/g) or greater (ASTM C1777-13) to provide a “pre-treated” fly ash, which then can be used to provide a cementitious system (e.g., mortar, concrete) which contains cement, aggregate, water, and the additive components (e.g., AEA(s), alkoxylated fatty compound, carbon dispersing compounds and alkanolamine compounds). A suitable addition rate, depending on the amount of carbon in fly ash, might be from 2 to 4000 ppm based on total cementitious material by solid weight. Similarly, detection of the MB value can be used to guide the treatment level.

In still further exemplary methods of the invention, the components are mixed together before addition to fly ash. In such methods, the air entraining agent preferably comprises a wood resin, a sulfonated hydrocarbon, a fatty acid, a synthetic surfactant, or mixture thereof; and the carbon-dispersing agent comprises a lignosulfonate, melamine sulfonate compound, naphthalene sulfonate compound, polyvinyl alcohol, polyvinylpyrrolidone, urea formaldehyde compound, a polysaccharide, or mixture thereof; and the at least one alkanolamine comprises methyldiethanolamine, diethanolamine, triethanolamine, triisopropanolamine, diethanolisopropanolamine, diisopropanolethanolamine, tetrahydroxy-ethylethylenediamine, tetra-hydroxyisopropyl-ethylenediamine, or mixtures thereof.

In further exemplary embodiments, one or more AEAs of Component A and one or more alkoxylated fatty compounds of Component B and carbon-dispersing agent of Component C are mixed together before addition to fly ash.

In still further exemplary embodiments, the cement and aggregate can be combined with fly ash and additive composition. For example, an exemplary method comprises: combining with a carbon-bearing fly ash having an MB value of 1 (mg/g) or greater, at least one air entraining agent, an alkoxylated fatty compound having at least one propylene oxide group and turbidity higher than 50 NTU (and preferably higher than 500 NTU, and more preferably higher than 1000 NTU), as measured in a 0.2 weight percent aqueous solution, at least one carbon dispersing component and at least one alkanolamine, and water. Alternatively, the components can be mixed together before addition to fly ash. Again, different modes of addition may require different relative amounts and ratios of Components A through E to be used.

With respect to exemplary methods of addition, it is preferred to use one or more AEAs selected from the group consisting of a wood resin, a sulfonated hydrocarbon, a fatty acid, a synthetic surfactant, or mixture thereof; and also preferred to use one or more alkanolamine components selected from the group consisting of methyldiethanolamine, diethanolamine, triethanolamine, triisopropanolamine, diethanolisopropanolamine, diisopropanolethanolamine, tetrahydroxy-ethylethylenediamine, tetra-hydroxyisopropyl-ethylenediamine, or mixtures thereof.

Hence, an exemplary composition of the invention comprises: a hydratable cementitious binder; carbon-bearing fly ash; aggregates; an alkoxylated fatty compound comprising at least one propylene oxide group and at least one saturated or unsaturated alkyl chain of 8 to 22 carbons, the alkoxylated fatty compound having a turbidity value which exceeds 50 NTU, more preferably exceeds 500 NTU, and most preferably exceeds 1000 NTU (as measured in 0.2 weight percent aqueous solution); at least one agent for dispersing carbon within an aqueous environment, said carbon-dispersing agent being selected from the group of lignosulfonate, melamine sulfonate compound, naphthalene sulfonate compound, polyvinyl alcohol, polyvinylpyrrolidone, urea formaldehyde compound, and polysaccharide; and, optionally, (i) at least one air entraining agent; (ii) at least one alkanolamine selected from the group consisting of methyldiethanolamine, diethanolamine, triethanolamine, triisopropanolamine, diethanolisopropanolamine, diisopropanolethanolamine, tetrahydroxy-ethylethylenediamine, tetra-hydroxyisopropyl-ethylenediamine, or mixtures thereof; or (iii) both components (i) and (ii). Preferred compositions and methods may involve using at least one air entraining agent (AEA) mixed together with the alkoxylated fatty compound and carbon-dispersing agent, such as when modifying a mortar or concrete mix; or adding the AEA or AEAs separately to form a mortar or concrete mix which contains carbon-bearing fly ash.

In further exemplary embodiments, cement and aggregate are combined with carbon-bearing fly ash and the components mentioned above added separately or as a pre-mixed additive composition.

The following examples are given as a specific illustration of embodiments of the claimed invention. It should be understood that the invention is not limited to the specific details set forth in the examples.

### Example 1

### Comparative Example

The turbidity levels of alkoxylated fatty compounds having various turbidities, measured, as well as the turbidity level of an amine compound, were measured.

The turbidity of the alkoxylated fatty compound-containing aqueous solutions was measured with a HACH™ 2100N turbidimeter at 20 degrees Celcius under the NTU unit mode with “Ratio” on, “Signal avg” off, and “Auto range” option. The turbidimeter was calibrated by stabilized formazin turbidity standard supplied by HACH Company, which includes a set of five sealed vials of <0.1, 20, 200, 1000, and 4000 NTU standards. Water (99.8 g) and alkoxylated fatty compound (0.2 g) were mixed for 15 minutes by mechanical stirrer at 600 rpm, and turbidity of the resulting mixture was measured within 1 minute after mixing.

Air entrained concrete mixes were prepared using: Ordinary Portland Cement, 272 kg/m³ (458 lb/yd³); fly ash (type C, containing activated carbon), 92 kg/m³ (153 lb/yd³); water, 136 kg/m³ (230 lb/yd³); coarse aggregate, 1038 kg/m³ (1750 lb/yd³); fine aggregate, 787 kg/m3 (1326 lb/yd³); high range water reducer, 0.1 wt % based on dry weight of cement and fly ash; and compounds operated to improve air control. A conventional AEA, DARAVAIR®1000, available from Grace Construction Products, Cambridge, Mass., USA, was added at a dosage required to bring the plastic air content to about 8% by total plastic concrete volume. DARAVAIR®1000 AEA is based on a high-grade saponified rosin formulation, and chemically resembles vinsol-based products. Air content of samples was tested in accordance with the ASTM C231-97 at 9 minutes and 30 minutes. The MB value of this type C fly ash is determined at 1.65 (mg/gm) according to ASTM C1777-13 method.

It is the objective of this invention that air loss be minimized or avoided as much as possible, which means stable air content and structure over time. As a minimum requirement, air change over time should be less than 2%.

In Table 1 below, alkoxylated fatty compound samples designated as Types “C1” and “C2” were found to be the most effective in this regard, as these achieved 30 minutes stable air at 40 parts per million (ppm) and at 20 ppm addition levels, respectively. The sample compound designated as Type “C3” was also found to be effective, as it reduced air loss to below 2% at 40 ppm addition level. The alkoxylated fatty compound used in C3 had fewer propylene oxide units and lower turbidity value. The present inventors believe that the performance of Type C3 is not as good as those found for Types C1 or C2.

On the contrary, for sample numbers 8 to 18, these used ethoxylated fatty compounds which did not result in sufficient avoidance of air loss, or which otherwise required significantly higher addition levels (see e.g., Entry 10). For samples 19 to 20, the alkoxylated compound known commercially as Jeffamine® ED900 (available from Huntsman Chemicals) was not effective for stabilizing air.

TABLE 1

| | Alkoxylated fatty compound | | | | | | | | |
|---|---|---|---|---|---|---|---|---|---|
| | (ppm based on total cementitious material) | | | | | | | | |
| | | | Propylene | | | Concrete plastic air % | | | |
| | | Alkyl | oxide unit per | Turbidity | | | | Air | Air |
| Entry | Type | group | molecule | (NTU) | ppm | @9 min | @30 min | loss | stability |
| 1 | — | — | — | — | — | 8.4 | 3.7 | 4.7 | No |
| 2 | C1 | C18 | 30-40 | 2376 | 6 | 8.0 | 4.6 | 3.4 | No |
| 3 | C1 | C18 | 30-40 | 2376 | 20 | 8.0 | 5.0 | 3.0 | No |
| 4 | C1 | C18 | 30-40 | 2376 | 40 | 7.9 | 7.8 | −0.1 | Yes |
| 5 | C2 | C18 | 20-30 | 1730 | 20 | 8.0 | 6.4 | 1.6 | Yes |
| 6 | C3 | C14-C18 | 2 | 57.5 | 20 | 8.5 | 4.0 | 4.5 | No |
| 7 | C3 | C14-C18 | 2 | 57.5 | 40 | 7.9 | 6.0 | 1.9 | Yes |
| 8 | PEO (5) Oleyl | C18 | 0 | 321 | 20 | 7.0 | 3.2 | 3.8 | No |
| | alcohol | | | | | | | | |
| 9 | PEO (5) Oleyl | C18 | 0 | 321 | 40 | 8.2 | 3.5 | 4.7 | No |
| | alcohol | | | | | | | | |
| 10 | PEO (5) Oleyl | C18 | 0 | 321 | 100 | 8.5 | 7.2 | 1.3 | Yes |
| | alcohol | | | | | | | | |
| 11 | PEO(7) Oleyl | C18 | 0 | 40.0 | 40 | 6.8 | 3.4 | 3.4 | No |
| | alcohol | | | | | | | | |
| 12 | PEO(7) Oleyl | C18 | 0 | 40.0 | 100 | 9.5 | 4.3 | 5.2 | No |
| | alcohol | | | | | | | | |
| 13 | PEO(23) Lauryl | C12 | 0 | 0.9 | 12 | 7.8 | 4.2 | 3.6 | No |
| | alcohol | | | | | | | | |
| 14 | PEO(23) Lauryl | C12 | 0 | 0.9 | 20 | 9.0 | 4.0 | 5.0 | No |
| | alcohol | | | | | | | | |
| 15 | PEO(23) Lauryl | C12 | 0 | 0.9 | 40 | 9.2 | 6.2 | 3.0 | No |
| | alcohol | | | | | | | | |
| 16 | PEO(23) Lauryl | C12 | 0 | 0.9 | 100 | 7.9 | 3.8 | 4.1 | No |
| | alcohol | | | | | | | | |
| 17 | PEO(50) Oleyl | C18 | 0 | 0.7 | 40 | 8.3 | 3.9 | 4.4 | No |
| | alcohol | | | | | | | | |
| 18 | PEO(50) Oleyl | C18 | 0 | 0.7 | 100 | 7.9 | 3.6 | 4.3 | No |
| | alcohol | | | | | | | | |
| 19 | Jeffamine ED900 | — | — | 0.33 | 40 | 7.2 | 2.7 | 4.5 | No |
| 20 | Jeffamine ED900 | — | — | 0.33 | 100 | 9.0 | 4.5 | 4.5 | No |

The above example demonstrated that the higher turbidity (e.g., 500 NTU) and use of propylene oxide units were important to effective air control.

### Example 2

This example illustrates a preparation procedure and some recipes of exemplary additive compositions of the present invention. An exemplary additive composition can be prepared by combining water (19.2 g), alkoxylated fatty compound designated as Type C1 (0.4 g), rosin acid (0.4 g), and 50% lignosulfonate solution (80 g) into a flask under stirring, then continue stirring until mixture become homogeneous. The resulting formula is listed as F2 in Table 2 below. Other exemplary additive compositions illustrated in table 2 can be prepared using similar formulation procedure.

TABLE 2

| | | | Alkoxylated | | | | | |
|---|---|---|---|---|---|---|---|---|
| Formula | Water | | fatty compound | | AEA | | Other ingredients | |
| F1 | 98.5 | g | C1 | 1 g | Rosin acid | 0.5 g | none | — |
| F2 | 19.2 | g | C1 | 0.4 g | Rosin acid | 0.4 g | 50% Lignosulfonate | 80 g |
| | | | | | | | solution | |
| F3 | 18.8 | g | C1 | 0.8 g | Rosin acid | 0.4 g | 50% Lignosulfonate | 80 g |
| | | | | | | | solution | |
| F4 | 18.8 | g | C1 | 0.8 g | Rosin acid | 0.4 g | 50% NSFC | 80 g |
| F5 | 98.8 | g | C2 | 1 g | Sodium lauryl sulfate | 0.2 g | — | |
| F6 | 18.8 | g | C2 | 0.8 g | Tall oil fatty acid | 0.4 g | 50% Lignosulfonate | 80 g |
| | | | | | | | solution | |
| F7 | 18.1 | | C1 | 0.8 g | Octylphenol ethoxylate | 0.3 g | 50% Lignosulfonate | 80 g |
| | | | C3 | 0.8 g | | | solution | |
| F8 | 18.1 | | C1 | 0.8 g | Sodium dodecylbenzene | 0.3 g | 50% Lignosulfonate | 80 g |
| | | | C3 | 1.6 g | sulfonate | | solution | |

### Example 3

This example demonstrates improved air control and regulation of AEA dosage when the exemplary additive compositions formulated according to the present invention are employed in cementitious systems containing fly ash and activated carbon.

Air entrained concrete mixes were prepared using: Ordinary Portland Cement (272 kg/m³ (458 lb/yd³)); fly ash (type C, containing activated carbon) (92 kg/m³ (153 lb/yd³)); water (136 kg/m³ (230 lb/yd³)); coarse aggregate (1038 kg/m³ (1750 lb/yd³)); fine aggregate (787 kg/m³ (1326 lb/yd³)); a polycarboxylate water-reducer available from Grace Construction Products of Cambridge, Mass., under the brand name ADVACAST® 600 (0.1 wt % based on weight of cement and fly ash). Into these concrete mixes, various formulated samples were introduced to examine air control properties.

A conventional AEA (DARAVAIR®1000) was added at a dosage required to bring the air content within the plastic concrete to within the range of 5%-9% by total volume based on plastic concrete volume. The air content of samples was tested in accordance with ASTM C231-97 at 9 minutes and 30 minutes. The air void quality was tested in accordance with the ASTM C457-98. The MB values of type C fly ash were determined according to ASTM C1777-13. The experimental results are summarized in Table 3 below.

A control experiment using fly ash without carbon (MB 0.35 mg/g) was also carried out as a referenced in entry 1. The carbon fly ash used in entry 2-4 had an MB value of 1.65 mg/g; another carbon fly ash used in entry 5-6 had MB value of 1.59 mg/g; and the third carbon fly ash having an MB value 2.3 mg/g was used in entry 7-8.

As can be seen when entries 1 through 4 are compared, the fly ash having an MB value of 1.65 mg/g without treatment corresponded to air loss of 4.7% over 30 minutes which is not commercially acceptable; while both F1 and F3 seemed to work in avoiding severe air loss.

As can be seen when entries 5 and 6 are compared, the untreated fly ash having an MB value of 1.59 mg/g suffered air loss of 4.6% over 30 min; while formula F1 appeared to reduce air loss to 0.5%. Because of air loss in entry 5, it also had poor quality air voids with spacing factor of 0.0144 inch. Good air entrained concrete should have spacing factor of less than 0.008 inch. (The concept of spacing factor is well understood to refer to the maximum distance in the cement paste from the periphery of an air void, and customarily used in describing air void structures (see e.g., ASTM C-457-09)). While a good air void structure was achieved in the present case by adding treatment formula F1 (AEA and fatty acid compound) alone, it was discovered that without the use of a carbon-dispersing agent (such as a lignosulfonate), a greater amount of alkoxylated fatty compound needs to be employed, and a decrease in dosage dispensing accuracy is more likely.

A similar comparison can be made between entries 7 and 8, with the fly ash with MB 2.30 mg/g. Starting air voids are comparable at 8.0% and 8.1%. Concrete with the untreated fly ash having MB value of 2.30 mg/g lost 5.3% over 30 minutes, while formula F3 appeared to reduce air loss to 2.1%. Because of air loss in entry 7, it also had poor quality air voids with spacing factor of 0.0107 inch. Spacing factor for entry 8 was 0.0052 inch, which is favorably below the 0.008 inch required to limit freeze thaw damage in concrete.

TABLE 3
(Concrete Test)

| | Fly ash | Compositions | | | | | | Spacing |
|---|---|---|---|---|---|---|---|---|
| | MB value | for air control* | | AEA | Concrete plastic air % | | | factor |
| Entry | (mg/g) | Type | ppm | (oz/cwt) | @9 min | @30 min | Air loss | (inches) |
| 1 | 0.35 | — | — | 1.2 | 8.2 | 6.6 | 1.6 | 0.0099 |
| 2 | 1.65 | — | — | 0.5 | 8.4 | 3.7 | 4.7 | NA |
| 3 | 1.65 | F1 | 60 | 0.53 | 7.6 | 7.8 | 0.2 | 0.0084 |
| 4 | 1.65 | F3 | 600 | 0.6 | 9.4 | 7.5 | 1.9 | NA |
| 5 | 1.59 | — | — | 0.20 | 8.7 | 4.1 | 4.6 | 0.0144 |
| 6 | 1.59 | F1 | 15 | 0.70 | 7.0 | 6.5 | 0.5 | 0.0077 |
| 7 | 2.30 | — | — | 1.2 | 8.0 | 2.7 | 5.3 | 0.0107 |
| 8 | 2.30 | F3 | 400 | 2.0 | 8.1 | 6.0 | 2.1 | 0.0052 |

*ppm level is based on total cementitious material, solid on solid.

### Example 4

This example illustrates the achievement of improved air control and regulation of AEA dosages when additive compositions are formulated in accordance with the present invention in cementitious systems containing fly ash and activated carbon.

Air entrained concrete mixes were carried out with similar fashion to Example 3 using: Ordinary Portland Cement (218 kg/m³ (367 lb/yd³); fly ash (type C, containing activated carbon) (74 kg/m³ (122 lb/yd³)), water (168 kg/m³ (284 lb/yd³)), coarse aggregate (1038 kg/m³ (1750 lb/yd³)), fine aggregate (787 kg/m³ (1326 lb/yd³)), WRDA®64 water reducer (available from Grace Construction Products, Cambridge, Mass.) (5 ounces per 100 pounds based on weight of cement and fly ash). Into these concrete samples the additive compositions were introduced.

A conventional air-entraining agent (DARAVAIR®1000 from Grace Construction Products) was added at a dosage required to bring the plastic air content within the range of 5%-9% by total volume based on plastic concrete. The experiment results are summarized in Table 4 below.

A control experiment using fly ash without carbon (MB value 0.35 mg/g) was also carried out as a reference in entry 1. When untreated carbon containing fly ash having high MB value (entries 2, 5, and 8) are used, unacceptable air losses were observed. And when entry 2 (untreated carbon fly ash) is compared with each of entries 3 and 4 (treated carbon fly ash), the formulated additive compositions designated as F1 and F3 were confirmed to lower air loss to acceptable levels (2% or below) and to reduce the AEA demand fluctuation caused by the presence of carbon. When entries 5 to 7 are compared, one observes that both formula F1 and F2 decrease air loss from 3.1% to 0.9% and 0.7%, respectively. Similar results were observed when entries 10 and 8 are compared, wherein F3 was observed to regulate the abnormally high AEA demand and stabilize air content over time. The dosage of entry 9 was shown to be not enough for fly ash with MB value of 2.3 mg/g.

Again, although formula F1 (AEA and fatty acid compound) alone was found to reduce air loss over time, it was again established that without the use of a carbon-dispersing agent (such as a lignosulfonate), a greater amount of alkoxylated fatty compound needs to be employed in the formulation and a decrease in dosage dispensing accuracy is more likely.

TABLE 4
(Concrete Test)

| | Fly ash | Compositions | | | Concrete plastic air % | | |
|---|---|---|---|---|---|---|---|
| | MB value | for air control* | | AEA | | | Air |
| Entry | (mg/g) | Type | ppm | (oz/cwt) | @9 min | @30 min | loss |
| 1 | 0.35 | — | — | 0.6 | 9.0 | 8.5 | 0.5 |
| 2 | 1.65 | — | — | 1.3 | 7.4 | 4.3 | 2.7 |
| 3 | 1.65 | F1 | 60 | 0.7 | 8.0 | 6.0 | 2.0 |
| 4 | 1.65 | F3 | 400 | 0.87 | 8.8 | 7.2 | 1.6 |
| 5 | 1.59 | — | — | 0.80 | 7.0 | 3.7 | 3.1 |
| 6 | 1.59 | F1 | 15 | 0.87 | 6.4 | 5.5 | 0.9 |
| 7 | 1.59 | F2 | 400 | 0.87 | 8.7 | 8.0 | 0.7 |
| 8 | 2.30 | — | — | 2.6 | 8.0 | 4.5 | 3.5 |
| 9 | 2.30 | F3 | 400 | 1.5 | 8.7 | 5.5 | 3.2 |
| 10 | 2.30 | F3 | 800 | 1.5 | 8.7 | 8.0 | 0.7 |

*ppm level is based on total cementitious material, solid on solid.

### Example 5

The impact of additives on entrained air was evaluated in mortar. The mortar was made with 500 g total cementitious content, 1 bag of EN sand (1350 g), and a water/cement ratio of 0.4. Density measurements were used to determine mortar air content. The cementitious content is either Ordinary Portland Cement (OPC) or a blend of OPC and Fly Ash (in the amount of 25% by weight of OPC).

In mortar, 1000 ppm of a rosin acid-based concrete air entraining agent DARAVAIR®1000 (AEA) will entrain air in a mortar with OPC to 9.2%. With 25% of a class C fly ash replacing the OPC, the entrained air content is lowered to 7.2%. When 2% PAC (powdered activated carbon) is added to the mix containing OPC and fly ash, the entrained air content is further diminished to 3.7%.

TABLE 5
(Reference Air Values)

| | Percent air with rosin acid |
|---|---|
| | based AEA at 1000 ppm |
| Mortar with OPC | 9.2% |
| Mortar with OPC/FA* | 7.2% |
| Mortar with OPC/FA/PAC** | 3.7% |

*25% fly ash replacing OPC
**25% fly ash with 2% PAC (powdered activated carbon) replacing OPC

Various additives such as calcium lignosulfonate, melamine or naphthalene sulfonate compound, polyvinyl alcohol, polyvinylpyrrolidone, or mixtures thereof, can be used in various embodiments of the invention to mitigate the impact of carbon on air entrainment of the OPC/FA/PAC system (where “PAC”=powdered activated carbon as defined above). The objective in some of these exemplary embodiments may include returning the level of entrained air in concrete to at least 7.2% with 1000 ppm rosin acid-based AEA. No additive tested alone is able to improve the level of entrained air in mortar or concrete to the target of 7.2% at the dosages tested. Higher dosages of the additives are not recommended in this system. Calcium lignosulfonate at dosages higher than 200 ppm can retard set time of mortar to a level that will inhibit concrete finishing in this system. The impact of triisopropanolamine will plateau at higher dosages. Both polyvinyl alcohol and polyvinylpyrrolidone become prohibitively expensive at dosages higher than 50 ppm.

TABLE 6

| | Mortar or other Cementitious Mix | | | |
|---|---|---|---|---|
| | 1 | 2 | 3 | 4 |
| Calcium lignosulfonate (ppm) | 200 | | | |
| Triisopropanolamine (ppm) | | 25 | | |
| Polyvinyl alcohol (ppm) | | | 50 | |
| Polyvinylpyrrolidone (ppm) | | | | 50 |
| Mortar Air % w/ | 5.1 | 4.2 | 6.5 | 4.7 |
| DARAVAIR ®1000 | | | | |
| AEA at 1000 ppm | | | | |

When the components were combined with a low dosage of an alkoxylated fatty compound and a low dosage of an AEA (sodium dodecylbenzene sulfonate or rosin aqueous solution), air entrainment in mortar exceeded the target of 7.2% in a mortar cement made from Ordinary Portland Cement and fly ash, as shown in Table 7 below.

TABLE 7

| | Mortar Mix | | | | |
|---|---|---|---|---|---|
| | 5 | 6 | 7 | 8 | 9 |
| Calcium lignosulfonate (ppm) | 200 | 200 | 200 | 200 | 200 |
| Triisopropanolamine (ppm) | 25 | 50 | 50 | 50 | 50 |
| Polyvinyl alcohol (ppm) | — | — | 50 | — | — |
| Polyvinylpyrrolidone (ppm) | — | 50 | — | — | — |
| Alkoxylated fatty compound | 10 | 10 | 10 | 10 | 20 |
| (type C1 in table 1) (ppm) | | | | | |
| Sodium dodecylbenzene | — | — | — | 2.5 | 5 |
| sulfonate (ppm) | | | | | |
| Rosin aqueous solution | 10 | 10 | 10 | — | — |
| (ppm active) | | | | | |
| Mortar Air % w/ | 7.6 | 8.2 | 8.7 | 7.7 | 8.0 |
| DARAVAIR ®1000 | | | | | |
| AEA at 1000 ppm | | | | | |

### Example 6

Alkoxylated fatty compounds are not inherently stable in an aqueous formulation. In formulations where nothing is done to stabilize the alkoxylated fatty compound, it will sit on the surface of the formulation as a thin clear layer. Diutan gum is used to stabilize the alkoxylated fatty compound in formulations 2d and 2e below. Diutan gum used in the amount of about 0.016 grams was used to stabilize 0.60 grams of alkoxylated fatty compound in the formulation, but lower levels of diutan gum did not maintain stability, as shown in Table 8 below.

TABLE 8

| | Formu- | Formu- | Formu- | Formu- |
|---|---|---|---|---|
| | lation | lation | lation | lation |
| | 2d | 2e | 2g | 2i |
| Component | grams | Solids | Solids | Solids |
| diutan gum | 0.022 | 0.016 | 0.0082 | 0.0042 |
| Alkoxylated fatty | 0.57 | 0.60 | 0.63 | 0.65 |
| compound | | | | |
| diethanolisopropanolamine | 9.46 | 9.98 | 10.55 | 10.86 |
| TOTAL weight* | 25.00 | 25.00 | 25.00 | 25.00 |
| | Stable | Stable | Unstable | Unstable |

*Balance of weight made up with water

The use of Diutan gum is a preferred stabilizer or viscosity modifying agent in combination with alkoxylated-fatty-compound-containing compositions and methods of the invention.

The foregoing illustrations and examples are provided for illustrative purposes only and not intended to limit the scope of the invention.

1. A method for controlling air in a hydratable cementitious composition containing carbon-bearing fly ash, comprising:
mixing together, with a cement or cement clinker and a carbon-containing fly ash having a methylene blue (MB) value of at least 1 milligram/gram (mg/g) or greater according to ASTM C1777-13, which carbon-containing fly ash operates to detrain air or otherwise to diminish the effect of air entraining agents within mortar and concrete which contains the cement or clinker,
an alkoxylated fatty compound comprising at least one propylene oxide group and at least one saturated or unsaturated alkyl chain of 8 to 22 carbons, the alkoxylated fatty compound having a turbidity value which exceeds 50 Nephelometric Turbidity Units (NTU) (as measured in a 0.2 weight percent aqueous solution);
at least one agent for dispersing carbon within an aqueous environment, said carbon-dispersing agent being selected from the group of lignosulfonate, melamine sulfonate compound, naphthalene sulfonate compound, polyvinyl alcohol, polyvinylpyrrolidone, urea formaldehyde compound, and polysaccharide; and
(i) at least one air entraining agent, (ii) at least one alkanolamine selected from the group consisting of methyldiethanolamine, diethanolamine, triethanolamine, triisopropanolamine, diethanolisopropanolamine, diisopropanolethanolamine, tetrahydroxy-ethylethylenediamine, tetra-hydroxyisopropyl-ethylenediamine, or mixtures thereof; or (iii) a mixture of the at least one air entraining agent described above in (i) and the at least one alkanonolamine described above in (ii).

2. (canceled)

3. The method of claim 1 wherein the cement or cement clinker and the carbon-containing fly ash are mixed with an air entraining agent.

4. The method of claim 1 wherein the cement or cement clinker and the carbon-containing fly ash are mixed with an alkanolamine.

5. The method of claim 1 wherein the at least one alkoxylated fatty compound and the at least one agent for dispersing carbon within an aqueous environment are in the form of an aqueous liquid composition with the cement or cement clinker and the carbon-containing fly ash.

6. (canceled)

7. The method of claim 1 wherein at least one alkoxylated fatty compound and the at least one agent for dispersing carbon within an aqueous environment are in the form of a dry powder.

8. The method of claim 1 wherein said alkoxylated fatty compound has a turbidity value which exceeds 500 NTU as measured in a 0.2 weight percent aqueous solution.

9. The method of claim 1 wherein said alkoxylated fatty compound has a turbidity value which exceeds 1000 NTU as measured in a 0.2 weight percent aqueous solution.

10. The method of claim 1 wherein the alkoxylated fatty compound contains saturated or unsaturated alkyl chain of 14-18 carbons.

11. The method of claim 1 wherein the alkoxylated fatty compound comprises (i) ethylene oxide (EO); (ii) propylene oxide (PO), and (iii) optionally butylene oxide (BO), wherein the molar ratio of ethylene oxide to total alkylene oxide (EO/EO+PO+BO) is equal to or less than fifty percent (≦50%).

12. (canceled)

13. (canceled)

14. The method of claim 1 further comprising aggregates for making mortar or concrete.

15. (canceled)

16. (canceled)

17. The method of claim 1 wherein the cement or cement clinker and the carbon-bearing fly ash is mixed with an aggregate.

18. The method of claim 1 wherein the at least one alkoxylated compound and the at least one carbon-dispersing agent are mixed with the carbon-containing fly ash using at least one thickening agent selected from the group consisting of diutan gum, welan gum, xanthan gum, and mixture thereof.

19. A composition comprising: a hydratable cementitious binder; carbon-bearing fly ash having a methylene blue (MB) value of 1 mg/g or greater
